(19) United States
(12) Patent Application Publication
(10) Pub. No.: US 2011/0315303 A1
(43) Pub. Date: Dec. 29, 2011

(54) COMPOSITE-REINFORCING FABRIC HAVING INDICATOR FIBER YARNS AND METHOD OF REPAIRING COMPOSITE COMPONENT USING THE SAME

(76) Inventor: Steven Kent Bird, Bend, OR (US)

(21) Appl. No.: 12/825,178

(22) Filed: Jun. 28, 2010

(51) Int. Cl. B32B 43/00; D03D 13/00; D03D 15/00

(52) U.S. Cl. 156/94; 442/181; 442/203; 442/187

(57) ABSTRACT

A composite-reinforcing fabric includes reinforcing fiber yarns interwoven with each other along a first direction and a second direction, wherein an exterior appearance of each of the reinforcing fiber yarns is the same. Indicator fiber yarns are interwoven with the reinforcing fiber yarns and an exterior appearance of each of the indicator fiber yarns is different from the exterior appearance of each of the reinforcing fiber yarns. Composite components formed using the composite-reinforcing fabric are disclosed, as are methods of repairing composite components using the composite-reinforcing fabric.

### BACKGROUND

1. Technical Field

This disclosure relates generally to composite-reinforcing fabrics and methods of repairing composite components. More specifically, this disclosure relates to composite-reinforcing fabrics having indicator fiber yarns and methods of repairing composite components using the same.

2. Description of the Related Art

The use of composites as components of modern aircraft is expanding. Increasingly, large portions of an aircraft's structure may be manufactured from composite material, including wings and fuselage skins, certain substructures, aerodynamic surfaces, and engine/exhaust components. The benefits of using composite components include high strength-to-weight ratio, corrosion resistance, thermal stability, and long fatigue life. Typically, these composite components are susceptible to small area damage during operational use from items such as stones, hail, shrapnel, and the like. Additionally, damage may occur from maintenance workstands and dropped tools while the aircraft is undergoing maintenance activities. Unfortunately, damage to these composite components is not easily repaired unless a bolted repair can be applied. Bolted repairs, however, will not properly restore the form, fit, and function of many composite components. If a bolted repair is inappropriate, a bonded patch repair is required.

The ideal repair of a composite component is one that fully restores its structural integrity to what it was before it was damaged. The best way to achieve full restoration is to, among other things, ensure that the components of a repair patch (e.g., repair plies) are properly aligned with respect to plies of reinforcing fabric within the composite component. Unfortunately, it is often a difficult and time consuming task to properly orient repair plies of a repair patch with plies of reinforcing fabric within the composite component.

### BRIEF DESCRIPTION OF THE DRAWINGS

FIG. 1A illustrates a somewhat schematic top plan view of a composite-reinforcing fabric according to one embodiment of the present invention;

FIG. 1B illustrates a somewhat schematic top plan view of a composite-reinforcing fabric according to another embodiment;

FIG. 1C illustrates a somewhat schematic top plan view of a composite-reinforcing fabric according to yet another embodiment;

FIG. 2A illustrates a somewhat schematic end view of an indicator fiber yarn incorporated within the composite-reinforcing fabric shown in any of FIGS. 1A-1C, according to one embodiment of the present invention;

FIG. 2B illustrates a somewhat schematic end view of an indicator fiber yarn incorporated within the composite-reinforcing fabric shown in any of FIGS. 1A-1C, according to another embodiment;

FIG. 3A illustrates a top plan view of a composite component having a repair area formed therein, according to one embodiment of the present invention;

FIG. 3B illustrates a cross-sectional view of the repair area in the composite component shown in FIG. 3A, taken along line IIIB-IIIB′ of FIG. 3A;

FIG. 4 illustrates a method repairing the composite component shown in FIGS. 3A and 3B, according to one embodiment of the present invention;

FIG. 5A illustrates a top plan view of the composite component shown in FIG. 3A, in which a repair ply has been arranged within a repair area, according to one embodiment;

FIG. 5B illustrates a top plan view of the composite component shown in FIG. 3A, in which a repair ply has been arranged within a repair area, according to another embodiment; and

FIG. 6 illustrates an example of a chart suitable for reference by a repair technician to repair a composite component, according to one embodiment.

### DETAILED DESCRIPTION OF THE EMBODIMENTS

Example embodiments are described below with reference to the accompanying drawings. Many different forms and embodiments are possible without deviating from the spirit and teachings of the invention and so the disclosure should not be construed as limited to the example embodiments set forth herein. Rather, these example embodiments are provided so that this disclosure will be thorough and complete, and will convey the scope of the invention to those skilled in the art. In the drawings, the sizes and relative sizes of components may be exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-section illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to embodiments exemplarily described herein, a composite-reinforcing fabric can be generally characterized as including reinforcing fiber yarns interwoven with each other along a first direction and a second direction, and indicator fiber yarns interwoven with the reinforcing fiber yarns such that more than one of the reinforcing fiber yarns runs at least substantially parallel to and between two adjacent indicator fiber yarns. An exterior appearance of each of the indicator fiber yarns is different from the exterior appearance of each of the reinforcing fiber yarns. By interweaving indicator fiber yarns within the composite-reinforcing fabric, identification of a ply of the composite-reinforcing fabric within a composite component can be facilitated. Additionally, the indicator fiber yarns aid in determining the particular orientation of a ply of the composite-reinforcing fabric within a composite component.

In one embodiment, the first direction and the second direction are oriented at substantially 90 degrees relative to each other. In other embodiments, however, the angle formed between the first and second directions may be acute or obtuse.

In one embodiment, the indicator fiber yarns extend unidirectionally within the composite-reinforcing fabric. In other embodiments, however, the indicator fiber yarns extend along more than one direction within the composite-reinforcing fabric. For example, the indicator fiber yarns may extend bidirectionally within the composite-reinforcing fabric.

In one embodiment, the reinforcing fiber yarns within the composite-reinforcing fabric have the same exterior appearance. In other embodiments, however, the exterior appearance of one of the reinforcing fiber yarns can be different from the exterior appearance of least one of the other reinforcing fiber yarns. Likewise the indicator fiber yarns within the composite-reinforcing fabric can, in one embodiment, have the same exterior appearance. In other embodiments, however, the exterior appearance of one of the indicator fiber yarns can be different from the exterior appearance of least one of the other indicator fiber yarns.

As described herein, the exterior appearance of the reinforcing fiber yarns and the indicator fiber yarns refers to one or more characteristics such as the color, reflectivity, texture, or the like, or a combination thereof, of the exterior surface of the reinforcing fiber yarns and the indicator fiber yarns.

Each of the reinforcing fiber yarns and indicator fiber yarns includes a bundle of fibers formed of a fiber material. Within a fiber yarn, the bundle of fibers is provided as a twisted bundle of continuous fibers, or as an untwisted bundle of continuous fibers. The fiber material of any fiber yarn may be any suitable material such as glass (e.g., E-glass, S-glass, etc.), carbon (e.g., AS4, T300, etc.) aramid, boron, graphite (pitch), ceramic (e.g., silicon carbide, alumina, etc.), or the like. All of the fibers within a reinforcing fiber yarn may be formed of the same fiber material or be formed of different fiber materials. Likewise, all of the fibers within an indicator fiber yarn may be formed of the same fiber material or be formed of different fiber materials. The fiber material(s) included within one of the reinforcing fiber yarns may be the same as or different from the fiber material(s) included within at least one of the other reinforcing fiber yarns. Likewise, the fiber material(s) included within one of the indictor fiber yarns may be the same as or different from the fiber material(s) included within at least one of the other indicator fiber yarns.

In one embodiment, fibers included in the reinforcing fiber yarns are formed of a different material from fibers included in the indicator fiber yarns. For example, the reinforcing fiber yarns may include glass fibers exhibiting little or no color, transparent or translucent exterior whereas the indicator fiber yarns include carbon fibers exhibiting a generally black or dark grayish, opaque exterior. In another example, the reinforcing fiber yarns may include undyed glass fibers exhibiting little or no color whereas the indicator fiber yarns include dyed glass fibers exhibiting a color such as red, green, blue, or the like, or a combination thereof.

In another embodiment, the reinforcing fiber yarns and indicator fiber yarns include fibers formed from the same fiber material. In such an embodiment, each of the indicator fiber yarns further includes an indicator material located on at least one of the fibers included therein. The indicator material is selected such that the appearance of the indicator material is different from the appearance of the fiber material. For example, the indicator material may be provided as a powder or resin that is coated onto the exterior surface of each of the fibers before or after they are bundled together to form an indicator fiber yarn. In another example, the indicator material may be provided as fiber material of fibers that have been processed (e.g., oxidized, nitrided, anodized, etc.) to change their exterior appearance before or after they are bundled together to form an indicator fiber yarn.

In one embodiment, a single indicator fiber yarn is interposed between two adjacent reinforcing fiber yarns along the first direction. In other embodiments, however, multiple indicator fiber yarns are interposed between two adjacent reinforcing fiber yarns along the first direction.

In one embodiment, at least two adjacent indicator fiber yarns are spaced apart from each other along the first direction by a distance of about 6 mm (or 6 mm) to about 26 mm (or 26 mm).

In one embodiment, a weave pattern formed by the interwoven reinforcing fiber yarns is the same as a weave pattern formed indicator fiber yarns interwoven with the reinforcing fiber yarns. In other embodiments, however, the weave pattern formed by the interwoven reinforcing fiber yarns is different from the weave pattern formed indicator fiber yarns interwoven with the reinforcing fiber yarns. The interwoven reinforcing fiber yarns may form any suitable weave pattern. For example, the interwoven reinforcing fiber yarns may form at least one weave pattern selected from the group consisting of a plain weave, basket weave, leno weave, crowfoot weave, eight harness satin weave, and twill weave. The weave pattern formed by the indicator fiber yarns and the interwoven reinforcing fiber yarns may be any suitable weave pattern. For example, the weave pattern formed by the indicator fiber yarns and the interwoven reinforcing fiber yarns may be at least one selected from the group consisting of a plain weave, basket weave, leno weave, crowfoot weave, eight harness satin weave, and twill weave.

According to embodiments exemplarily described herein, a prepreg can be generally characterized as including a composite-reinforcing fabric, as exemplarily described with respect to any of the embodiments mentioned above, and a polymeric material at least partially encapsulating the reinforcing fiber yarns and the indicator fiber yarns.

According to embodiments exemplarily described herein, a composite component can be generally characterized as including a laminate of fabric plies and a polymeric material at least partially encapsulating the fabric plies within the laminate. Each of the fabric plies can be provided as exemplarily described with respect to any of the embodiments mentioned above.

In one embodiment, each fabric ply in the composite component has the same weave pattern. In other embodiments, however, a fabric ply in the composite component may have a weave pattern that is different from that of another fabric ply in the composite component.

In one embodiment, the indicator fiber yarns extend unidirectionally within at least one of the fabric plies. In other embodiments, however, the indicator fiber yarns extend along more than one direction within at least one of the fabric plies. For example, the indicator fiber yarns may extend bidirectionally within at least one of the fabric plies.

In one embodiment, the exterior appearance of the reinforcing fiber yarns in one of the fabric plies is the same as an exterior appearance of the reinforcing fiber yarns in another of the fabric plies. In other embodiments, however, the exterior appearance of the reinforcing fiber yarns in one of the fabric plies is different from the exterior appearance of the reinforcing fiber yarns in another of the fabric plies.

In one embodiment, the exterior appearance of each of the indicator fiber yarns in one of the fabric plies is different from the exterior appearance of each of the indicator fiber yarns in another of the fabric plies. For example, the exterior appearance of each of the indicator fiber yarns in the one of the fabric plies may be different from the exterior appearance of each of the indicator fiber yarns in a fabric ply adjacent to the one of the fabric plies. In another example, the exterior appearance of each of the indicator fiber yarns in the one of the fabric plies is different from the exterior appearance of each of the indicator fiber yarns in each of the other fabric plies. In other embodiments, however, the exterior appearance of each of the indicator fiber yarns in one of the fabric plies is the same as the exterior appearance of each of the indicator fiber yarns in another of the fabric plies. For example, the exterior appearance of each of the indicator fiber yarns in the one of the fabric plies may be the same as the exterior appearance of each of the indicator fiber yarns in a fabric ply adjacent to the one of the fabric plies. In another example, the exterior appearance of each of the indicator fiber yarns in the one of the fabric plies may be the same as the exterior appearance of each of the indicator fiber yarns in each of the other fabric plies. In one embodiment, the exterior appearance of each of the indicator fiber yarns in every-other fabric ply of the laminate may be the same. For example, the exterior appearance of each of the indicator fiber yarns in a fabric ply may alternate between one of two different exterior appearances within a laminate of sequentially arranged fabric plies.

According to embodiments exemplarily described herein, a method of repairing a composite component generally includes forming a repair area within a composite component comprising a laminate of composite plies, preparing at least one repair ply configured to fit within the repair area, arranging the at least one repair ply within repair area and bonding the at least one repair ply arranged within the repair area to the at least one composite ply. In this method, at least one of the composite plies includes a fabric of reinforcing fiber yarns interwoven with each other and at least one indicator fiber yarn interwoven with and having an exterior appearance different from the reinforcing fiber yarns. The repair area extends through the at least one composite ply and exposes the at least one indicator fiber yarn of the at least one composite ply. The at least one repair ply includes a fabric of reinforcing fiber yarns interwoven with each other and at least one indicator fiber yarn interwoven with, and having an exterior appearance different from, the reinforcing fiber yarns. The at least one repair ply is arranged within the repair area such that the at least one indicator fiber yarn in the at least one repair ply has a predetermined orientation with respect to the at least one indicator fiber yarn of the at least one composite ply.

In one embodiment, the at least one indicator fiber yarn in the at least one repair ply has the predetermined orientation with respect to the at least one indicator fiber yarn of the at least one composite ply when the at least one indicator fiber yarn in the at least one repair ply extends along at least substantially the same direction as the at least one indicator fiber yarn of the at least one composite ply. In other embodiments, however, the at least one indicator fiber yarn in the at least one repair ply has the predetermined orientation with respect to the at least one indicator fiber yarn of the at least one composite ply when the at least one indicator fiber yarn in the at least one repair ply form an angle (e.g., at least substantially 90 degrees) relative to the direction along which the at least one indicator fiber yarn of the at least one composite ply extends.

In one embodiment, the at least one repair ply is arranged within the repair area by arranging the at least one repair ply such that the at least one indicator fiber yarn in the at least one repair ply is at least substantially collinear with the at least one indicator fiber yarn of the at least one composite ply. In other embodiments, however, the at least one repair ply is arranged within the repair area by arranging the at least one repair ply such that the at least one indicator fiber yarn in the at least one repair ply is not substantially collinear with the at least one indicator fiber yarn of the at least one composite ply.

In one embodiment, the exterior appearance of the at least one indicator fiber yarn in the at least one composite ply is substantially the same as the exterior appearance of the at least one indicator fiber yarn in the repair ply. In other embodiments, the exterior appearance of the at least one indicator fiber yarn in the at least one composite ply is different from the exterior appearance of the at least one indicator fiber yarn in the repair ply.

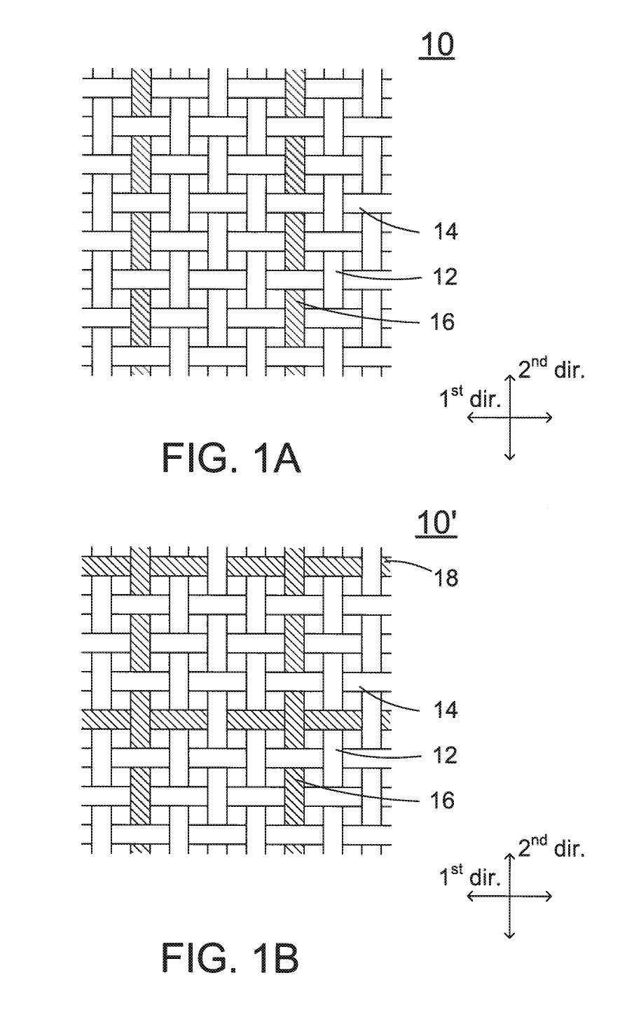

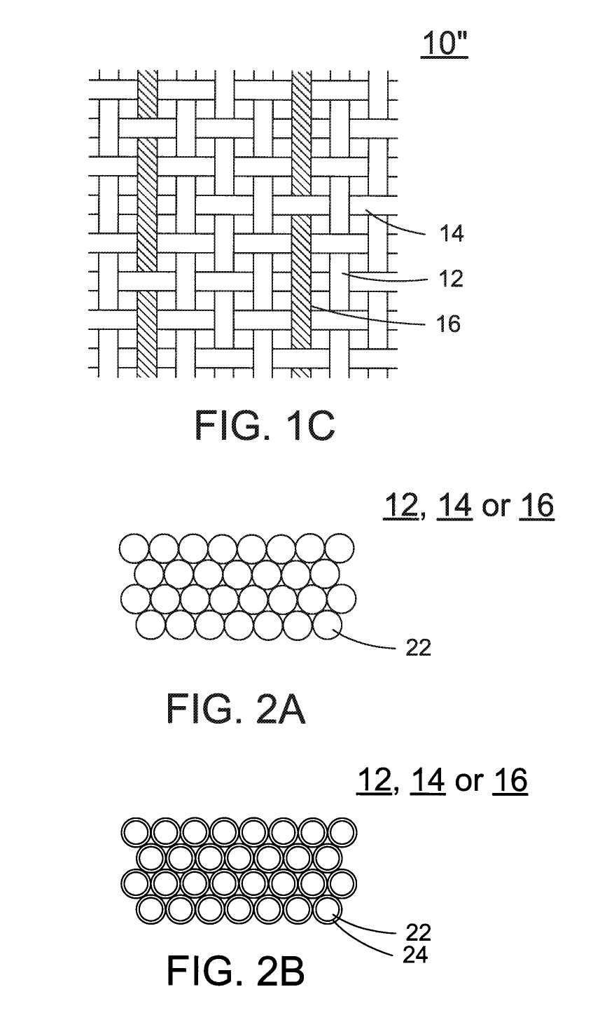

Examples of the some of the above-described embodiments are discussed with reference to FIGS. 1A to 5B.

FIG. 1A illustrates a somewhat schematic top plan view of a composite-reinforcing fabric according to one embodiment of the present invention. FIG. 1B illustrates a somewhat schematic top plan view of a composite-reinforcing fabric according to another embodiment. FIG. 1C illustrates a somewhat schematic top plan view of a composite-reinforcing fabric according to yet another embodiment.

Referring to FIG. 1A, a composite-reinforcing fabric 10 can be generally characterized as including first reinforcing fiber yarns 12 and second reinforcing fiber yarns 14 (collectively referred to herein simply as “reinforcing fiber yarns”) interwoven with each other along a first direction (e.g., labeled “1^{st} dir.”) and a second direction (e.g., labeled “2^{nd} dir.”) and indicator fiber yarns 16 extending unidirectionally within the composite-reinforcing fabric 10 so as to be interwoven with the second reinforcing fiber yarns 14. The first direction and the second direction may, for example, be at least substantially perpendicular to each other. As illustrated, more than one first reinforcing fiber yarn 12 runs at least substantially parallel to and between two adjacent indicator fiber yarns 16. Also, a single indicator fiber yarn 16 is interposed between two adjacent first reinforcing fiber yarns 12 along the first direction.

As disclosed herein, an exterior appearance of the reinforcing fiber yarns and the indicator fiber yarns of each of the indicator fiber yarns 16 is different from the exterior appearance of each of the reinforcing fiber yarns 12 and 14. For example, the color of the exterior surface of each of the indicator fiber yarns 16 may be different from the color of the exterior surface of each of the reinforcing fiber yarns 12 and 14. However, the exterior appearances the reinforcing fiber yarns 12 and 14 are the same. As used herein, the exterior appearance of a reinforcing fiber yarn or an indicator fiber yarn (each generally described as a “fiber yarn”) refers to one or more characteristics such a color, reflectivity, texture, or the like, of the exterior surface of the fiber yarn.

At least two adjacent indicator fiber yarns 16 are spaced apart from each other along the first direction by a distance of about 6 mm (or 6 mm) to about 26 mm (or 26 mm).

A weave pattern formed by the interwoven reinforcing fiber yarns 12 and 14 is the same as a weave pattern formed indicator fiber yarns 16 interwoven with the second reinforcing fiber yarns 14. The interwoven reinforcing fiber yarns 12 and 14 may form any suitable weave pattern. For example, the interwoven reinforcing fiber yarns 12 and 14 may form a plain weave pattern.

As exemplarily described above with respect to FIG. 1A, the indicator fiber yarns 16 extend unidirectionally within the composite-reinforcing fabric 10. In other embodiments, however, the indicator fiber yarns 16 may extend along more than one direction within the composite-reinforcing fabric.

For example, with reference to FIG. 1B, a composite fabric 10′ may be provided in a similar manner as the composite-reinforcing fabric 10, but include indicator fiber yarns 18 in addition to the indicator fiber yarns 16. Thus, indicator fiber yarns 16 and 18 extend bidirectionally within the composite-reinforcing fabric 10′.

As also shown in FIG. 1 B, the indicator fiber yarns 18 are interwoven with the first reinforcing fiber yarns 12 such that more than one second reinforcing fiber yarn 14 runs at least substantially parallel to and between two adjacent indicator fiber yarns 18. The exterior appearance of each of the indicator fiber yarns 16 is the same as or different from the exterior appearance of each of the indicator fiber yarns 18. At least two adjacent indicator fiber yarns 18 may be spaced apart from each other along the second direction by a distance of about 6 mm (or 6 mm) to about 26 mm (or 26 mm).

As exemplarily described above with respect to FIG. 1A, a weave pattern formed by the interwoven reinforcing fiber yarns 12 and 14 is the same as a weave pattern formed indicator fiber yarns 16 interwoven with the second reinforcing fiber yarns 14. In other embodiments, however, the weave pattern formed by the interwoven reinforcing fiber yarns is different from the weave pattern formed indicator fiber yarns interwoven with the reinforcing fiber yarns.

For example, with reference to FIG. 1C, a composite fabric 10″ may be provided in a similar manner as the composite-reinforcing fabric 10. In the composite fabric 10″, however, the weave pattern formed by the interwoven reinforcing fiber yarns 12 and 14 is different from the weave pattern formed indicator fiber yarns 16 interwoven with the reinforcing fiber second yarns 14. As exemplarily shown in FIG. 1C, the weave pattern formed by the interwoven reinforcing fiber yarns 12 and 14 provides a one-to-one interface wherein each first reinforcing fiber yarn 12 floats over one second reinforcing fiber yarn 14 and under one second reinforcing fiber yarn 14 in an alternating manner. However, the weave pattern formed indicator fiber yarns 16 interwoven with the reinforcing fiber second yarns 14 provides a three-to-one interface wherein each indicator fiber yarn 16 floats over three second reinforcing fiber yarns 14 before sinking under one second reinforcing fiber yarn 14.

FIG. 2A illustrates a somewhat schematic end view of a reinforcement or indicator fiber yarn incorporated within the composite-reinforcing fabric shown in any of FIGS. 1A-1C, according to one embodiment of the present invention. FIG. 2B illustrates a somewhat schematic end view of a reinforcement or indicator fiber yarn within the composite-reinforcing fabric shown in any of FIGS. 1A-1C, according to another embodiment.

Referring to FIG. 2A, the term “fiber yarn” generally refers to a twisted or untwisted bundle of continuous fibers. Thus, each of the reinforcing fiber yarns 12 and 14 and each of the indicator fiber yarns 16 includes a twisted or untwisted bundle of fibers 22. Each fiber 22 is formed of a fiber material. Generally, the fiber material may be a material having a tensile strength in a range of about 0.2×10⁶ psi to about 0.8×10⁶ psi, a specific strength in a range of about 0.1×10⁶ psi to about 0.4×10⁶ psi, a modulus of elasticity in a range of about 10.5×10⁶ psi to about 73×10⁶ psi, and a specific modulus in a range of about 4×10⁶ psi to about 52×10⁶ psi. For example, the fiber material may be any suitable material such as glass (e.g., E-glass, S-glass, R-glass, etc.), carbon (e.g., AS4, T300, etc.) aramid, boron, graphite (pitch), ceramic (e.g., silicon carbide, alumina, etc.), or the like.

In one embodiment, each fiber 22 within a fiber yarn is formed of the same fiber material. In other embodiments, however, a fiber 22 within a fiber yarn may be formed of a different fiber material from at least one other fiber 22 within the fiber yarn. In one embodiment, the fiber material(s) included within one of the reinforcing fiber yarns 12 or 14 in the composite fabric 10 may be the same as or different from the fiber material(s) included within at least one of the other reinforcing fiber yarns 12 or 14 in the composite fabric 10. Similarly, the fiber material(s) included within one of the indicator fiber yarns 16 in the composite fabric 10 may be the same as or different from the fiber material(s) included within at least one of the other indicator fiber yarns 16 in the composite fabric 10.

According to some embodiments of the present invention, the fiber material(s) included within one of the indicator fiber yarns 16 in the composite fabric 10 are different from the fiber material(s) included within the reinforcing fiber yarns 12 and 14. For example, the reinforcing fiber yarns 12 and 14 may include glass fibers exhibiting a transparent or translucent exterior having little or no color whereas the indicator fiber yarns 16 may include carbon fibers exhibiting a generally black or dark grayish opaque exterior. In another example, the reinforcing fiber yarns may include undyed glass fibers exhibiting little or no color whereas the indicator fiber yarns include dyed glass fibers exhibiting a color such as red, green, blue, black, or the like, or a combination thereof. Dyeing of the fibers can be accomplished by any known technique (e.g., by dyeing fiber material while it is in a liquid state, before the fiber material is extruded into fiber form).

Referring to FIG. 2B, the fiber material(s) included within one of the indicator fiber yarns 16 in the composite fabric 10 are the same as the fiber material(s) included within the reinforcing fiber yarns 12 and 14. Therefore, an indicator material 24 may be provided on the fibers 22 of the indicator fibers yarns 16 and/or the reinforcing fiber yarns 12 and 14 to ensure that the indicator fibers yarns 16 in the composite-reinforcing fabric 10 have a different exterior appearance from the reinforcing fiber yarns 12 and 14 in the composite-reinforcing fabric 10.

In one embodiment, the indicator material 24 is coated onto the fibers 22 of a fiber yarn. In such an embodiment, the indicator material 24 may include a powder or a resin that is applied to fibers 22 before or after the fibers 22 are bundled together into a fiber yarn. In another embodiment, however, the indicator material 24 is a portion of a fiber 22 that has been processed (e.g., oxidized, nitrided, anodized, etc.) before or after the fibers 22 are bundled together into a fiber yarn.

As exemplarily described above, a composite-reinforcing fabric is provided with reinforcing fiber yarns and indicator fiber yarns, wherein the indicator fiber yarns each have an exterior appearance which is different from that of each of the reinforcing fiber yarns. The presence of the indicator fiber yarns facilitates identification of a particular ply of the composite-reinforcing fabric within a composite component, facilitates determining the particular orientation of a ply of the composite-reinforcing fabric within a composite component and facilitates.

The composite-reinforcing fabric described herein can also be incorporated within a prepreg material. Accordingly, a prepreg according to some embodiments of the present invention can be generally characterized as including a composite-reinforcing fabric and a polymeric material at least partially encapsulating the reinforcing fiber yarns and the indicator fiber yarns of the composite-reinforcing fabric. Example materials of polymeric material suitable for use in the prepreg include epoxy, phenolic resin, and bismaleimide compounds. Prepregs incorporating the composite-reinforcing fabric described herein can be formed according to any suitable manufacturing technique (e.g., film transfer techniques, solution immersion or spreading techniques, etc.). A prepreg incorporating the composite-reinforcing fabric described herein can be advantageously used during the initial build-up process of a composite component where it can be important to ensure that adjacent plies are oriented correctly with respect to each other.

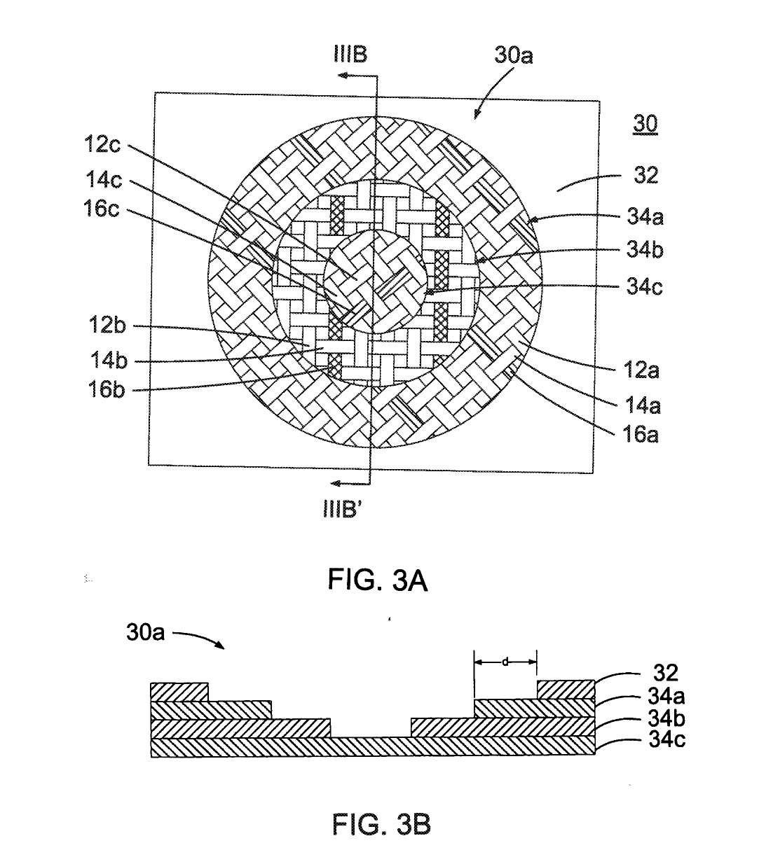

FIG. 3A illustrates a top plan view of a composite component having a repair area formed therein, according to one embodiment of the present invention. FIG. 3B illustrates a cross-sectional view of the repair area in the composite component shown in FIG. 3A, taken along line IIIB-IIIB′ of FIG. 3A.

Referring to FIGS. 3A and 3B, a composite component 30 can be generally characterized as including a laminate of fabric plies (also referred to herein as “composite plies”) and a polymeric material at least partially encapsulating the fabric plies within the laminate. As exemplarily illustrated, the laminate of fabric plies includes fabric ply 32 (also referred to herein as a “surface fabric ply”), fabric ply 34a (also referred to herein as a “first fabric ply”), fabric ply 34b (also referred to herein as a “second fabric ply”) and fabric ply 34c (also referred to herein as a “third fabric ply”). Within the composite component 30, the orientation of one of the fabric plies is different from an orientation of the fabric ply adjacent thereto. For example, the first fabric ply 34a may be oriented at −45° (or about −45°) within the composite component 30 while the second fabric ply 34b is oriented at 90° (or about 90°) within the composite component 30. Similarly, the third fabric ply 34c may be oriented at +45° (or about +45°) within the composite component 30. It will be appreciated, however, that the orientation of two adjacent fabric plies within the composite component 30 may be the same (or substantially the same).

Although FIGS. 3A and 3B illustrate only four fabric plies included within the laminate, it will be appreciated that the laminate of the composite component 30 may include more or less than the number of fabric plies illustrated. Because each of the fabric plies 32, 34a, 34b and 34c form part of the composite component 30, these plies are also be referred to as “composite plies.” FIGS. 3A and 3B illustrate the composite component 30 as having a repair area 30a. Generally, the repair area 30a corresponds to a region within the composite component 30 that has been damaged. Thus, it will be appreciated that an undamaged composite component 30 may not have a repair area 30a extending through the fabric plies 34a, 34b and 34c.

Each of the fabric plies 34a, 34b and 34c is provided as a composite-reinforcing fabric such as composite-reinforcing fabric 10. For example, fabric plies 34a, 34b and 34c each include first reinforcing fiber yarns 12a, 12b and 12c, respectively (collectively referred to as “first reinforcing fiber yarns”); second reinforcing fiber yarns 14a, 14b and 14c, respectively, (collectively referred to as “second reinforcing fiber yarns”) interwoven with respective ones of the first reinforcing fiber yarns, and indicator fiber yarns 16a, 16b and 16c, respectively (collectively referred to as “indicator fiber yarns”) interwoven with respective ones of the second reinforcing fiber yarns. The surface fabric ply 32 forms the exterior surface of the composite component 30, and may be provided as a composite-reinforcing fabric 10 or as any other type of fabric ply. As exemplarily illustrated, each of the fabric plies 34a, 34b and 34c in the composite component 30 has the same weave pattern, within which respective ones of the indicator fibers 16a, 16b and 16c extend unidirectionally.

As exemplarily illustrated, the exterior appearance of the reinforcing fiber yarns 12a and 14a in the first fabric ply 34a is the same as an exterior appearance of the reinforcing fiber yarns in 12b and 14b in the second fabric ply 34b as well as the reinforcing fiber yarns in 12c and 14c in the third fabric ply 34c. In other embodiments, however, the exterior appearance of the reinforcing fiber yarns in one of the fabric plies 34a, 34b and 34c may be different from the exterior appearance of the reinforcing fiber yarns in one or more of the other fabric plies 34a, 34b or 34c. For example, the exterior appearance of the reinforcing fiber yarns 12a and 14a in the first fabric ply 34a may be different from the exterior appearance of the reinforcing fiber yarns 12b and 14b in the second fabric ply 34b and/or different from the exterior appearance of the reinforcing fiber yarns 12c and 14c in the third fabric ply 34c.

As exemplarily illustrated, the exterior appearance of each of the indicator fiber yarns in one of the fabric plies 34a, 34b and 34c is different from the exterior appearance of each of the indicator fiber yarns in one or more of the other fabric plies 34a, 34b or 34c. For example, the exterior appearance of each of the indicator fiber yarns 16a in the first fabric ply 34a may be different from the exterior appearance of each of the indicator fiber yarns 16a in the second fabric ply 34b that is adjacent to the first fabric ply 34a. In another example, the exterior appearance of each of the indicator fiber yarns 16a in the first fabric ply 34a is different from the exterior appearance of each of the indicator fiber yarns 16b in the second fabric ply 34b and each of the indicator fiber yarns 16c in the third fabric ply 34c. Likewise, the exterior appearance of each of the indicator fiber yarns 16b in the second fabric ply 34b can be different from the exterior appearance of each of the indicator fiber yarns 16c in the third fabric ply 34c.

It will be appreciated that the composite component 30 can be used to form many types of structures (e.g., aerospace components such as tails, wings, fuselages, propellers, etc., boat hulls, storage tanks, and the like) according to any suitable technique. Indicator fiber yarns within the composite-reinforcing fabric described herein can be advantageously used during formation of the composite component 30 to ensure that adjacent fabric plies are oriented correctly with respect to each other and/or with respect to certain structures formed by the composite component 30.

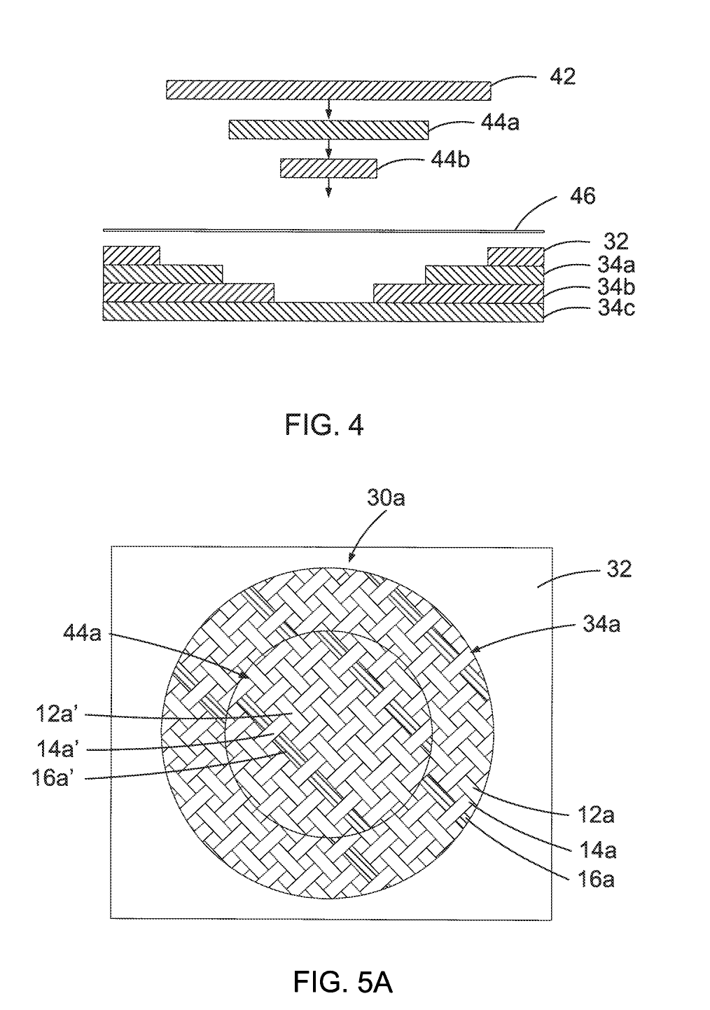

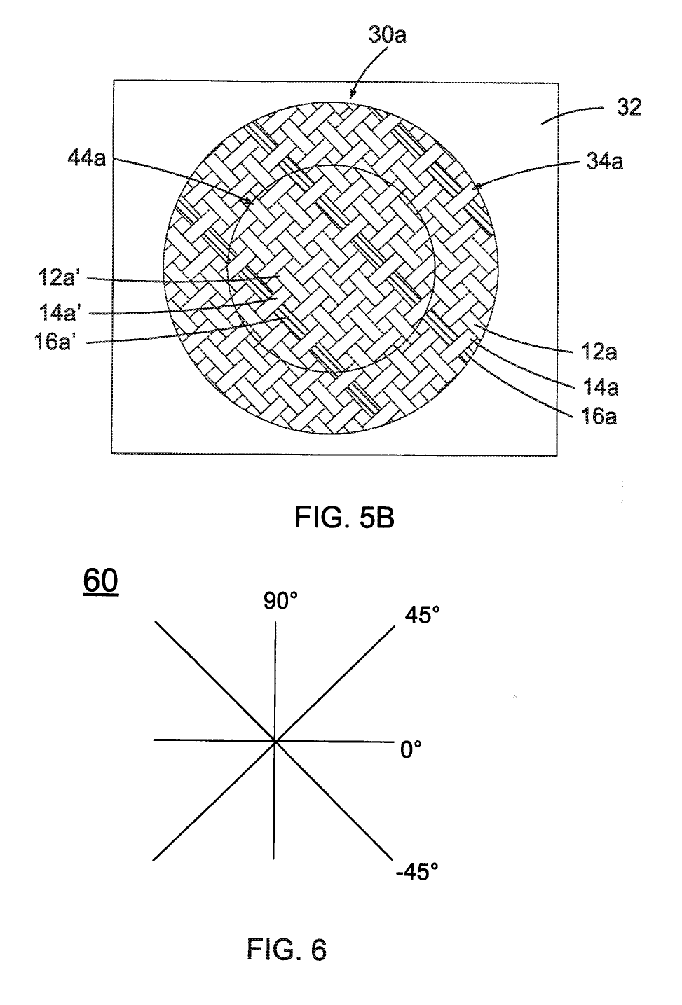

FIG. 4 illustrates a method repairing the composite component shown in FIGS. 3A and 3B, according to one embodiment of the present invention. FIG. 5A illustrates a top plan view of the composite component shown in FIG. 3A, in which a repair ply has been arranged within a repair area, according to one embodiment. FIG. 5B illustrates a top plan view of the composite component shown in FIG. 3A, in which a repair ply has been arranged within a repair area, according to another embodiment.

According to some embodiments of the present invention, a method of repairing a composite component generally includes forming a repair area such as repair area 30a (see FIGS. 3A and 3B) within a composite component such as composite component 30. In one embodiment, the repair area 30a may be prepared using grinding, sanding, or trimming methods to form a scarf exposing at least one fabric ply in the composite component 30. As exemplarily illustrated in FIGS. 3A and 3B, the scarf is formed as a stepped scarf extending through the surface fabric ply 32, the first fabric ply 34a and the second fabric ply 34b, and exposing upper surfaces of the first fabric ply 34a, the second fabric ply 34b and the third fabric ply 34c. In one embodiment, stepped scarf extends through the surface fabric ply 32, the first fabric ply 34a and the second fabric ply 34b to expose one or more indicator fiber yarns 16a in the first fabric ply 34a, one or more indicator fiber yarns 16b in the second fabric ply 34b and one or more indicator fiber yarns 16c in the third fabric ply 34c. Each step in the stepped scarf may have a depth, d, of at least 12.7 mm (or at least about 12.7 mm). Indicator fiber yarns within the first fabric ply 34a, the second fabric ply 34b and the third fabric ply 34c can be advantageously used during scarf formation to ensure that the scarf has been formed to properly expose each fabric ply therein. Thus, the indicator fiber yarns may be used to identify which fabric plies have been sanded though or otherwise removed, which can help when detecting damage to a composite component. Although the scarf is illustrated as a stepped scarf, the scarf may alternatively be formed as a tapered scarf After the scarf is formed, surfaces exposed within the repair area 30a, as well as a portion of the exterior surface of the surface fabric ply 32 surrounding the repair area 30a, can be cleaned by any suitable method.

At least one repair ply is prepared to fit within the repair area 30a so as to be proximate to (e.g., abut or be closely adjacent to) a composite ply exposed within the repair area 30a. Generally, fabric plies that are selected as repair plies have properties (e.g., mechanical properties) that are at least substantially the same as properties of the composite plies. In one embodiment, any repair ply may be formed from a prepreg material, in which a composite-reinforcing fabric such as composite-reinforcing fabric 10 is at least partially encapsulated with a polymeric material. In other embodiments, however, any repair ply may be formed from a dry composite-reinforcing fabric such as composite-reinforcing fabric 10, which can be manually encapsulated during a wet layup process or the like. A repair ply can be prepared by any suitable process (e.g., cutting an appropriately-sized shape out of a composite-reinforcing fabric such as composite-reinforcing fabric 10).

As exemplarily illustrated in FIG. 4 a surface repair ply 42, a first repair ply 44a and a second repair ply 44b are prepared to fit within the repair area 30a. Specifically, the surface repair ply 42 is prepared to fit within the portion of the repair area 30a extending through the surface fabric ply 32, the first repair ply 44a is prepared to fit within the portion of the repair area 30a extending through the first fabric ply 32a and the second repair ply 44b is prepared to fit within the portion of the repair area 30a extending through the second fabric ply 32b. Each of the repair plies 44a and 44b is provided as a composite-reinforcing fabric such as composite-reinforcing fabric 10. The surface repair ply 42 may be provided as a composite-reinforcing fabric such as composite-reinforcing fabric 10 or as any other type of fabric ply. Although the repair plies 42, 44a and 44b are illustrated as forming an upside-down “wedding cake” configuration in which the largest repair ply (i.e., the surface repair ply 42) is provided on top and the smallest repair ply (i.e., repair ply 44b) is provided on bottom, the repair plies 42, 44a and 44b may be sized in any suitable manner (e.g., to form a typical “wedding cake” configuration in which the largest repair ply is provided on bottom and the smallest repair ply is provided on top).

After preparing the repair area 30a and the repair plies 42, 44a and 44b, the repair plies are arranged within the repair area 30a. In one embodiment, the repair plies 44a and 44b are arranged such that at least one indicator fiber yarn in the at least one repair ply has a predetermined orientation with respect to the at least one indicator fiber yarn of a corresponding one of the fabric plies within the composite component 30. For example, referring to FIG. 5A, the first repair ply 44a can be arranged such that the indicator fiber yarns 16a′ included therein extend along at least substantially the same direction as the indicator fiber yams 16a of the first fabric ply 34a in the composite component 30. Reinforcing fiber yams within the first repair ply 44a are identified at 12a′ and 14a′, which may be provided as reinforcing fiber yams 12 and 14, respectively, described above with respect to FIG. 1. In another example, and with reference to FIG. 5B, the first repair ply 44a can be arranged such that the indicator fiber yams 16a′ included therein not only extend along at least substantially the same direction as the indicator fiber yarns 16a of the first fabric ply 34a in the composite component 30, but are also at least substantially collinear with indicator fiber yams 16a of the first fabric ply 34a. The second repair ply 44b can be similarly constructed with respect to the second fabric ply 34b of the composite component 30. Thus, as exemplarily shown above in FIGS. 5A and 5B, indicator fiber yarns in a repair ply have the predetermined orientation with respect to the indicator fiber yarns of a corresponding fabric ply in the composite component 30 when indicator fiber yarns in the repair ply extend along at least substantially the same direction as indicator fiber yarns of the corresponding fabric ply in the composite component 30. By ensuring that indicator fiber yams in repair plies have a predetermined orientation with indicator fiber yarns in composite plies, proper orientation between the repair and composite plies can be ensured, thereby ensuring that the composite component 30 is properly repaired. After arranging the repair plies 42, 44a and 44b within the repair area 30a, they are bonded to the fabric plies 32, 34a and 34b by any suitable method (e.g., by adhesive layer 46).

In one embodiment, the exterior appearance of the indicator fiber yams 16a′ in the first repair ply 44a is the same as the exterior appearance of the indicator fiber yarns 16a in the first fabric ply 34a of the composite component 30. Likewise, the exterior appearance of indicator fiber yarns in the second repair ply 44b may be the same as the exterior appearance of the indicator fiber yarns 16b in the second fabric ply 34b of the composite component 30. In other embodiments, the exterior appearance of indicator fiber yarns in a repair ply may be different from the exterior appearance of indicator fiber yarns in a corresponding fabric ply in composite component 30. Moreover, indicator fiber yarns need not be present in any of the repair plies. In such an embodiment, a repair technician would simply orient the repair plies using the indicator fiber yarns in each fabric ply of the composite component 30.

Selection of the proper composite-reinforcing fabric for use as a repair ply may be made in any suitable manner. For example, a repair technician could select the proper composite-reinforcing fabric by referring to a chart in a maintenance/repair manual identifying the orientation of each composite ply within the composite component 30, the color of each indicator fiber of each composite ply within the composite component 30, or the like, or a combination thereof. For example, referring to FIG. 6, a chart 60 having a plurality of lines, each corresponding to a different angle (e.g., 0°, 45°, 90°, and −45°) that corresponds to the orientation angle of a composite ply within the composite component 30. It will be appreciated that the number of lines illustrated in the chart and the angle of each illustrated line may vary depending on the number composite plies within the composite component and the orientation of each composite ply within the composite component 30. Moreover, each line in the chart 60 may be a different color that corresponds to the color of an indicator fiber of each composite ply within the composite component 30. It will be appreciated that the color of each illustrated line may vary depending on the color of the indicator fibers in the various composite plies within the composite component 30.

The foregoing is illustrative of example embodiments of the invention and is not to be construed as limiting thereof. Although a few example embodiments have been described, those skilled in the art will readily appreciate that many modifications are possible without materially departing from the novel teachings and advantages of the invention. Accordingly, all such modifications are intended to be included within the scope of the invention as defined in the following claims.

What is claimed is:

1. A composite-reinforcing fabric, comprising:
reinforcing fiber yarns interwoven with each other along a first direction and a second direction, wherein an exterior appearance of each of the reinforcing fiber yarns is the same; and
indicator fiber yarns interwoven with the reinforcing fiber yarns such that the indicator fiber yarns extend unidirectionally within the fabric and such that more than one of the reinforcing fiber yarns runs at least substantially parallel to and between two adjacent indicator fiber yarns,
wherein an exterior appearance of each of the indicator fiber yarns is different from the exterior appearance of each of the reinforcing fiber yarns, and
wherein a tensile strength of each of the reinforcing fiber yarns is in a range between about 0.2×10⁶ psi to about 0.8×10⁶ psi.

2. The composite-reinforcing fabric of claim 1, wherein the first direction is oriented at substantially 90 degrees relative to the second direction.

3. The composite-reinforcing fabric of claim 1, wherein a color of an exterior surface of each of the indicator fiber yarns is different from a color of an exterior surface of each of the reinforcing fiber yarns.

4. The composite-reinforcing fabric of claim 3, wherein each of the reinforcing fiber yarns comprises fibers formed of a fiber material selected from the group consisting of glass, carbon and an aramid.

5. The composite-reinforcing fabric of claim 4, wherein each of the indicator fiber yarns comprises fibers formed of a fiber material selected from the group consisting of glass, carbon and an aramid.

6. The composite-reinforcing fabric of claim 5, wherein each of the reinforcing fiber yarns and indicator fiber yarns comprises fibers formed from the same fiber material, wherein each of the indicator fiber yarns further comprises an indicator material located on at least one of the fibers included therein, and wherein an exterior appearance of the indicator material is different from an exterior appearance of the fiber material.

7. The composite-reinforcing fabric of claim 6, wherein the indicator material comprises at least one material selected from the group consisting of a powder and a resin.

8. The composite-reinforcing fabric of claim 1, wherein a single indicator fiber yarn is interposed between two adjacent reinforcing fiber yarns along the first direction.

9. The composite-reinforcing fabric of claim 1, wherein at least two adjacent indicator fiber yarns are spaced apart from each other along the first direction by a distance of about 6 mm to about 26 mm.

10. The composite-reinforcing fabric of claim 1, wherein a weave pattern formed by the interwoven reinforcing fiber yarns is the same as a weave pattern formed by the indicator fiber yarns interwoven with the reinforcing fiber yarns.

11. The composite-reinforcing fabric of claim 10, wherein the weave pattern formed by the interwoven reinforcing fiber yarns is a plain weave pattern.

12. A prepreg, comprising:
a composite-reinforcing fabric including:
reinforcing fiber yarns interwoven with each other along a first direction and a second direction, wherein an exterior appearance of each of the reinforcing fiber yarns is the same, and
indicator fiber yarns interwoven with the reinforcing fiber yarns such that the indicator fiber yarns extend unidirectionally within the fabric and such that more than one of the reinforcing fiber yarns runs at least substantially parallel to and between two indicator fiber yarns, wherein an exterior appearance of each of the indicator fiber yarns is different from the exterior appearance of each of the reinforcing fiber yarns; and
a polymeric material at least partially encapsulating the reinforcing fiber yarns and the indicator fiber yarns.

13. A composite component comprising:
a laminate of fabric plies, wherein each fabric ply includes:
reinforcing fiber yarns interwoven with each other along a first direction and a second direction, wherein an exterior appearance of each of the reinforcing fiber yarns is the same, and
indicator fiber yarns interwoven with the reinforcing fiber yarns such that more than one of the reinforcing fiber yarns runs at least substantially parallel to and between two adjacent indicator fiber yarns, wherein an exterior appearance of each of the indicator fiber yarns is different from the exterior appearance of each of the reinforcing fiber yarns; and
a polymeric material at least partially encapsulating the fabric plies within the laminate.

14. The composite component of claim 13, wherein the indicator fiber yarns extend bidirectionally within at least one of the fabric plies.

15. The composite component of claim 13, wherein the exterior appearance of the reinforcing fiber yarns in one of the fabric plies is the same as the exterior appearance of the reinforcing fiber yarns in another of the fabric plies.

16. The composite component of claim 13, wherein an exterior appearance of each of the indicator fiber yarns in one of the fabric plies is different from an exterior appearance of each of the indicator fiber yarns in another of the fabric plies.

17. The composite component of claim 16, wherein the exterior appearance of each of the indicator fiber yarns in the one of the fabric plies is different from the exterior appearance of each of the indicator fiber yarns in a fabric ply adjacent to the one of the fabric plies.

18. The composite component of claim 17, wherein an orientation of the one of the fabric plies within the composite component is different from an orientation of the fabric ply adjacent to the one of the fabric plies within the composite component.

19. The composite component of claim 18, wherein the exterior appearance of each of the indicator fiber yams in the one of the fabric plies is different from the exterior appearance of each of the indicator fiber yams in each of the other fabric plies.

20. A method of repairing a composite component, comprising:
forming a repair area within a composite component comprising a laminate of composite plies, wherein at least one of the composite plies comprises a fabric of reinforcing fiber yarns interwoven with each other and at least one indicator fiber yarn interwoven with and having an exterior appearance different from the reinforcing fiber yams, the repair area extending through the at least one composite ply and exposing the at least one indicator fiber yarn of the at least one composite ply;
preparing at least one repair ply configured to fit within the repair area, the at least one repair ply including a fabric of reinforcing fiber yams interwoven with each other and at least one indicator fiber yarn interwoven with and having an exterior appearance different from the reinforcing fiber yams;
arranging the at least one repair ply within repair area such that the at least one indicator fiber yarn in the at least one repair ply has a predetermined orientation with respect to the at least one indicator fiber yarn of the at least one composite ply; and
bonding the at least one repair ply arranged within the repair area to the at least one composite ply.

21. The method of claim 20, wherein the at least one indicator fiber yarn in the at least one repair ply has the predetermined orientation with respect to the at least one indicator fiber yarn of the at least one composite ply when the at least one indicator fiber yarn in the at least one repair ply extends along at least substantially the same direction as the at least one indicator fiber yarn of the at least one composite ply.

22. The method of claim 21, wherein arranging the at least one repair ply within repair area comprises arranging the at least one repair ply such that the at least one indicator fiber yarn in the at least one repair ply is at least substantially collinear with the at least one indicator fiber yarn of the at least one composite ply.

23. The method of claim 20, wherein the exterior appearance of the at least one indicator fiber yarn in the at least one composite ply is substantially the same as the exterior appearance of the at least one indicator fiber yarn in the repair ply.
